(19) United States
(12) Patent Application Publication
(10) Pub. No.: US 2003/0106774 A1
(43) Pub. Date: Jun. 12, 2003

(54) Device for conveying objects

(76) Inventor: Erwin Muller, Durnten (CH)

Correspondence Address: BRINKS HOFER GILSON & LIONE, P.O. BOX 10395, CHICAGO, IL, 60611, US

(21) Appl. No.: 10/258,188

(22) PCT Filed: Feb. 6, 2001
(86) PCT No.: PCT/CH01/00079

(30) Foreign Application Priority Data
Apr. 20, 2000 (CH) 800/00

(51) Int. Cl. B65G 43/00

(52) U.S. Cl. 198/460.3

(57) ABSTRACT

The device for conveying objects (14) consists of successively arranged conveyor elements (17) which can move along a conveyor path (16). A conveyor clamp is associated with each conveyor element. Said conveyor clamp is mounted on the conveyor element in such a way that it can be moved backwards and forth between two positions (22, 24) in a defined direction of conveyance relative to the conveyor path (16). A fixed control device (48) is provided in order to displace predetermined passing transport clamps from one position (22, 24) into another position (24, 22), thereby simplifying the processing and treatment of individual objects in a stream of objects.

The present invention relates to an arrangement for transporting, in particular, sheet-like articles according to the preamble of patent claim 1.

A transporting arrangement of this type is known, for example, from CH-A-382 768 and the corresponding U.S. Pat. No. 3,032,341. This transporting arrangement has individual conveying elements which are designed as carriages, are arranged one behind the other and are mounted such that they can be moved on a continuous guide rail. Arranged in a fixed manner on each conveying element is a controllable transporting clamp which is intended, at a receiving location arranged in a vertical portion of the guide rail, for receiving a fed printed product and securing the latter in order for it to be transported further. As soon as the transporting clamp has been provided with a printed product, the conveying element is released in order for the printed product to be transported, by being driven by gravitational force, along the conveying section formed by a portion of the guide rail.

Also known are arrangements for transporting printed products which has conveying elements which are likewise designed as carriages and arranged one behind the other, but are articulated on one another to form a continuous conveying chain. The conveying elements are mounted such that they can be moved in a cross-sectionally C-shaped guide rail. Arranged in a fixed manner on each transporting element is an individually controllable transporting clamp which is intended, at a receiving location, for receiving in each case one printed product and transporting the latter along a conveying section.

It is an object of the present invention to provide an arrangement of the generic type which, even in the case of conveying elements following closely one after the other, makes it possible to process predetermined articles.

This object is achieved by an arrangement which has the features of claim 1.

Preferred embodiments of the arrangement according to the invention are specified in the dependent patent claims.

The present invention is explained in more detail with reference to the exemplary embodiments illustrated in the drawing, in which, purely schematically:

FIG. 1 shows a perspective illustration of an article-retaining transporting clamp of which the clamp plane runs at right angles to the conveying direction and which is mounted on a conveying element such that it can be displaced back and forth in one of the arrow directions;

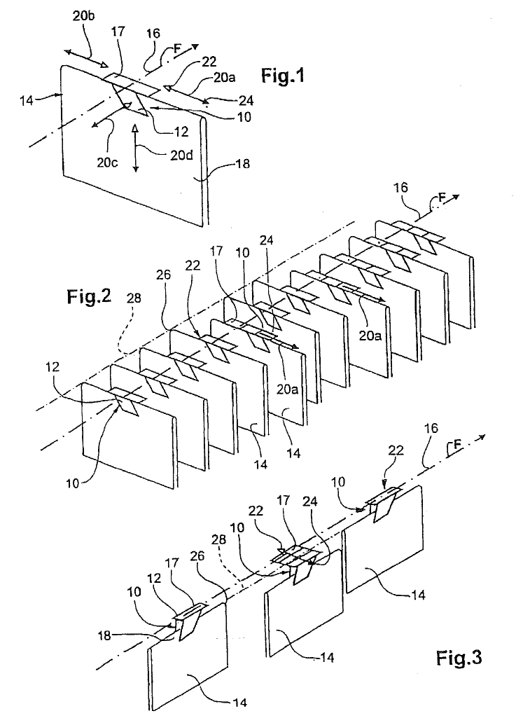

FIG. 2 shows a perspective illustration of a number of transporting clamps according to FIG. 1 each retaining an article, some of the transporting clamps being located in a first position and others having been displaced into a second position in relation to the conveying element;

FIG. 3 shows a perspective illustration of transporting clamps which are arranged at a distance one behind the other, have the clamp plane running in the conveying direction and each retain an article, the central transporting clamp having been displaced in a direction at right angles to the conveying direction in relation to the other two transporting clamps;

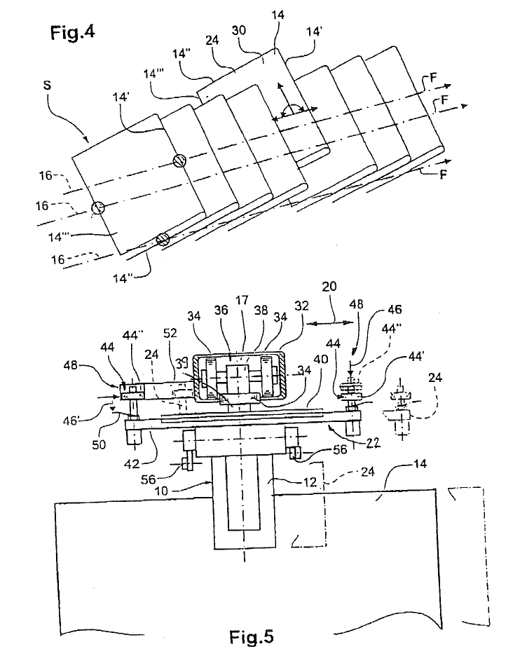

FIG. 4 shows an illustration, likewise in perspective, of a number of articles arranged in an imbricated formation, as well as different possible ways of securing these articles by means of transporting clamps;

FIG. 5 shows a view of an article-retaining transporting clamp mounted in a displaceable manner on a conveying element, as well as parts of a control arrangement for displacing the transporting clamp;

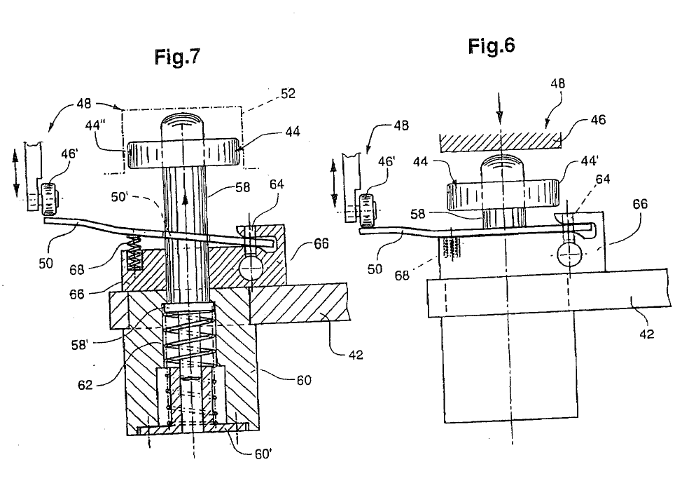

FIG. 6 shows a follower element arranged on the transporting clamp according to FIG. 5, as well as parts of the control arrangement for displacing the follower element into a rest position;

FIG. 7 shows, in section, the follower element according to FIG. 6, with elements of the control arrangement, displaced into an operating position;

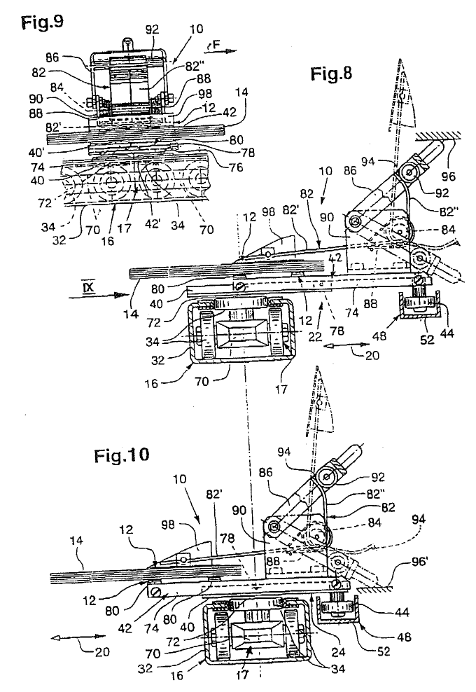

FIG. 8 shows a further embodiment of a transporting clamp arranged in a displaceable manner on a conveying element;

FIG. 9 shows the transporting clamp and the conveying element according to FIG. 8 in a side view in the direction of the arrow IX;

FIG. 10 shows the conveying element and the transporting clamp according to FIG. 8 with the transporting clamp displaced in relation to the conveying element; and

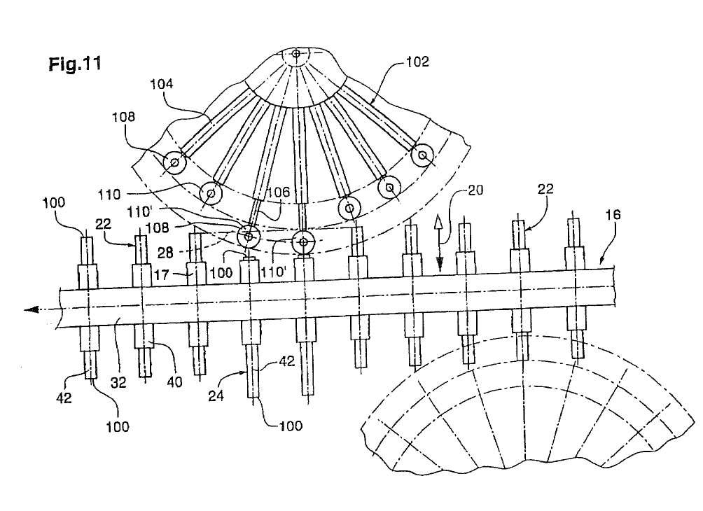

FIG. 11 shows a plan view of transporting clamps arranged one behind the other, and each retaining an article, and a further embodiment of the control arrangement for displacing transporting clamps in relation to the conveying elements.

FIG. 1 shows, schematically, a transporting clamp 10 which, by means of its two clamp elements 12, of which only one is visible, retains a sheet-like article 14, in the present case a folded printed product such as a newspaper, a periodical or the like. Chain-dotted lines indicate a portion of a conveying section 16 along which a conveying element 17, with transporting clamp 10 arranged thereon, is moved in the conveying direction F. The clamp elements 12 displaced into the clamping position define a clamp plane 18, in which the article 14 is retained. The clamp plane 18 runs at right angles to the conveying section 16. The transporting clamp 10 is mounted on the conveying element 17 such that it can be displaced back and forth between two positions, to be precise in the direction of one of the double arrows 20a, 20b, 20c, 20d, the hollow arrow tip in each case indicating a first position 22 and the filled-in arrow tip indicating a second position 24. The transporting clamp 10 shown, in respect of all the displacement directions 20, is in the first position 22. The double arrow 20a indicates that the transporting clamp 10 can be displaced to the right, as seen in the conveying direction F, from the first position 22 shown, in the horizontal displacement direction running at right angles to the conveying direction F, into the second position 24 and back again. Correspondingly, the double arrow 20b indicates that the transporting clamp 10 can be arranged in the conveying element such that it can be displaced to the left, from the first position 22 shown, into the second position 24 and back again. The double arrow 20c shows that the transporting clamp 10 may be arranged on the conveying element 17 such that it can be displaced in the direction of the conveying section 16. Finally, the double arrow 20d indicates that it is also conceivable for the transporting clamp 10 to be displaced vertically in relation to the conveying element 17.

FIG. 2 shows a portion of the conveying section 16 with a number of transporting clamps 10 which are arranged at the same distance one behind the other and each retain an article 14 in the hanging position. As described in conjunction with FIG. 1, the transporting clamps 10 are mounted on the associated conveying element 17 (not shown) such that they can be displaced in relation to the displacement direction 20 running at right angles to the conveying section 16. Six of the transporting clamps 10 shown are located in the first position 22, which is made more obvious by a chain-dotted line 28 running through a corner 26. Other transporting clamps 10 have been displaced in the direction of the arrow 20a from the first position 22 into the second position 24. The articles 14 thus displaced into the second position 24 project laterally, as seen in the conveying direction F, beyond the other articles 14, with the result that processing can be carried out thereon, for example on the projecting region, or they can be gripped, and received, by a clamp of a further transporting arrangement.

FIG. 3 shows three of a multiplicity of transporting clamps 10 which are moved at the same distance one behind the other in the conveying direction F along a conveying section 16 and have the clamping plane 18 running in the direction of the conveying section 16. These transporting clamps 10 too can be displaced, in the displacement direction 20 indicated by the double arrow, from a first position 22, which is assumed by the two outer transporting clamps 10 and is indicated by the chain-dotted line 28, into a second position 24 and back again, as is indicated by the central transporting clamp 10.

In the case of the embodiment shown in FIG. 4, the articles 14 are transported in an imbricated formation S in the conveying direction F, each of the articles 14 being retained by a transporting clamp. One of these transporting clamps, together with the article 14 it retains, has been displaced laterally into the second position 24, with the result that, of the top flat side of said article 14, a border region 30 running along the leading edge 14′ and along the left-hand lateral edge 14″, as seen in the conveying direction, and, of the bottom flat side, a border region 30 running along the trailing edge 14′″ and along the lateral edge 14″, are then exposed for the purpose of processing the relevant article 14. As is indicated with reference to the three conveying sections 16 and transporting clamps 10 assigned to the latter, these transporting clamps being indicated by a circle, the articles 14 may be retained either at the leading edge 14′ at the trailing edge 14′″ or at a lateral edge 14″, in the present case the one located on the right-hand side, as seen in the conveying direction. It is also conceivable here for it to be possible for the transporting clamps 10, as is indicated by the arrows, to be displaced transversely, in particular at right angles to, or in, and counter to, the conveying direction F in relation to the corresponding conveying elements.

FIG. 5 shows a cross-sectionally C-shaped continuous guide rail 32, in which there is arranged a generally known conveying chain which is guided on guide wheels 34 and forms a continuous conveying mechanism 36. A carrying body 39, which engages through the gap of the guide rail 32, projects from each member 38 of the conveying mechanism 36, formed by the conveying chain, one of the guide wheels 34 being mounted at one end of said carrying body, and a profile-like guide element 40 running at right angles to the conveying direction F being fastened at the free end of said carrying body. Mounted on said guide element is a likewise profile-like displacement element 42 which, at each of its two ends, bears a follower element 44 designed as a follower roller. The follower element 44 which is arranged at the right-hand end of the slide 42 is located in a rest position 44′ and the follower element 44 which is arranged at the left-hand end is located in an operating position 44″, in which it is spaced apart further from the slide 42 than in the rest position 44′. As is made obvious with reference to the first, arrow-indicated control element 46 of a control arrangement 48, it is possible for follower elements 44 located in the operating position 44″—indicated by dashed lines—to be displaced into the rest position 44′. By virtue of a clamping catch 50 being actuated by means of a second control element 46′, which is likewise indicated as an arrow, it is possible for follower elements 44 located in the rest position 44′ to be moved into their operating position 44″. This will be described in more detail with reference to FIGS. 6 and 7.

The follower element 44 which is located in the operating position 44″ and is arranged at the left-hand end of the slide 42 is guided in a displacement element 52 which is designed as a guide element and of which the distance from the guide rail 32 decreases continuously in the conveying direction F in a displacement portion of the conveying section 16. As a result, when the members 38 of the conveying mechanism 36, said members serving as conveying elements 17, move in the conveying direction F, those transporting clamps 10 of which the relevant follower element 44 is located in the operating position 44″ are displaced from the first position 22, which is illustrated by solid lines, into the second position 24, which is indicated by chain-dotted lines. The transporting clamp 10 fastened on the slide 42 may be a transporting clamp which is known from EP-A-0 600 183 and U.S. Pat. No. 5,395,151 and which has two clamp elements 12 which can be actuated by means of control levers 56.

In the case of the embodiment according to FIG. 5, it is possible for the displacement element 52, with the transporting clamp 10 arranged thereon, also to be displaced to the left from the first position 22, which is shown by solid lines, into a further position; this takes place in a manner analogous to the displacement into the second position 24.

FIGS. 6 and 7 show, on a larger scale than FIG. 5, the rest position 44′ and operating position 44″, respectively, of the follower element 44 which is arranged at the left-hand end of the slide 42 in FIG. 5. The slide 42 may have a follower element 44 at both ends or just at one end. The follower element 44, which is designed as a wheel, is mounted in a freely rotatable manner on a shank 58, which engages through an opening 50′ of a clamping catch 50 and is mounted on a guide body 60 fastened on the slide 42. By means of a compression spring which has one end supported on the removable base 60′ of the guide body 60, and has its other end supported on a shoulder 58′ of the shank 58, the latter is subjected to a force in the direction of the operating position 44″. The clamping catch 50, on the one hand, is mounted on a bearing body 66, likewise fastened on the slide 42, such that it can be pivoted in a lever-like manner—pin 64—and, on the other hand, is subjected to the force of a clamping spring 68, which is designed as a compression spring and is supported, on the one hand, on the clamping catch 50 and, on the other hand, on the bearing body 66. As seen in the longitudinal direction of the clamping catch 50, the opening 50′ is slightly larger than the cross section of the shank 58. In FIG. 7 the clamping catch 50 is located in the clamping position, in which the shank 58 is retained, under clamping action, either in the rest position 44′ or in the operating position 44″. In order for the follower element 44 to be displaced from the operating position 44″ into the rest position 44′, on the one hand, the clamping catch 50 is moved, by means of the second control element 46′ of the control arrangement 48, into the release position, as is shown in FIG. 46, and, on the other hand, the first control element 46 acts on the free end of the shank 58. If the follower element 44 has been displaced into the rest position 44′, the clamping catch 50 is released, with the result that it can be pivoted, under the action of the clamping spring 68, into the clamping position and secures the shank 58. In order for the follower element 44 to be displaced into the operating position 44″, the second control element 46′ is actuated, as a result of which the clamping catch 50 is pivoted into the release position and the shank 58, with the follower element 44, is displaced, under the action of the compression spring 62, into the operating position 44″, where it engages with the displacement element 52.

That embodiment of the arrangement according to the invention which is shown in FIGS. 8 to 10 has a multiplicity of individual conveying elements 17 which are arranged one behind the other in a cross-sectionally C-shaped, continuous guide channel 32. These conveying elements are each designed as carriages, their end sides 70 being in the form of striking surfaces. At least in the regions of the guide channel 32 with upward slopes—as seen in the conveying direction F—the conveying elements 17 located in this portion butt against one another, each conveying element moving the immediately preceding conveying element forward in the conveying direction F by striking against it. In particular in portions of the guide channel 32 with a downward slope, the conveying elements 17 can move independently of one another, driven by the gravitational force. It is also conceivable, however, for the conveying elements 17 to form a continuous succession of abutting conveying elements 17.

Each of the conveying elements 17 has, in the interior of the guide channel 32, four freely rotatably mounted guide wheels 34 and two further guide wheels 34 which are arranged one behind the other in the direction of the guide channel 32, are mounted in a freely rotatable manner on carrier elements 72 of the conveying element 17 and interact with the mutually facing borders of the guide channel 32 for lateral guidance purposes. A guide element 40 with guide 40′ arranged at right angles to the longitudinal direction of the guide channel 32 is fastened on the two carrier elements 72 of every second conveying element 17. A guide bead 42′ of the otherwise essentially plate-like slide 42 engages in the guide 40′, which is designed as a groove. Guide profiles 74 which are fastened on the slide 42 engage laterally around the essentially plate-like guide element 40. One of these guide profiles 74 has an approximately central bore, in which a spring-loaded latching ball 76 is arranged. The latter interacts, with a latching arrangement 78 being formed in the process, in the first position 22 (FIG. 8) and second position 24 (FIG. 10) with a corresponding depression in the guide element 40 in each case, in order for the slide 42 to be retained in a releasable manner in the corresponding position 22, 24.

Mounted in a freely rotatable manner at one end of the slide 42 is a follower element 44 which is designed as a roller. Said follower element is intended, in order to displace the slide 42 from one position 22 or 24 into the respectively other position 24 or 22, for interacting with a cross-sectionally U-shaped guide element, which forms a displacement element 52. This guide element may be controlled, for example, in order to act exclusively on the follower elements 44 of the predetermined slides 42 which are to be displaced.

Fastened on the slide 42, in the end region of the latter which is opposite the follower element 44 are two clamping rests 80 forming a clamp element 12. Interacting with said clamping rests is a planar clamp element 12 which is arranged at the free end of a first leg 82′ of a leaf spring 82. The latter is guided approximately 90° around a bearing shank 84 and the other, second leg 82″ of the leaf spring 82 is intended for interacting with a closing lever 86. Furthermore, in each case one opening spring 88 engages around the bearing shank 84 on both sides of the leaf spring 82, each of said opening springs, at one end, acting on the first leg 82′ and, at the other end, being supported on the lateral legs of a U-shaped bearing element 90. The latter is fastened on the slide 42, by way of its central leg, in the vicinity of the follower element 44. Both the bearing shank 84 and the U-shaped closing lever 86 are mounted on the two side legs of the bearing element 90. Said closing lever has a roller 92 which is mounted in a freely rotatable manner on it and, when the closing lever 86 is pivoted, rolls on the second leg 82″ of the leaf spring 82. As can be seen from FIGS. 8 and 10 in particular, the second leg 82″, at its free end, has a stop 94, against which the roller 92 butts in the closed position of the transporting clamp 10 in that it is forced against the stop 94, and thus retained in a stable position, by the direction and force of the second leg 82″. In order to open the transporting clamp 10, use is made, for example, of an opening guide element 96 which, when the transporting clamp 10 is moved in the conveying direction F, pivots the closing lever 86 downward from the closed position, which is shown by solid lines in FIGS. 8 and 10, into the open position, which is indicated by chain-dotted lines. Correspondingly, it is possible to provide, for example, a closing guide element 96′ for closing the transporting clamp 10. It should be ensured that a wedge-shaped cover 98 is fastened on the planar moving clamp element 12, in order, during displacement of the transporting clamp 10 in the displacement direction 20, to move beneath an article retained by an adjacent transporting clamp 10, without damaging said article.

FIG. 11 shows a portion of the conveying section 16 with conveying elements 17 which are arranged at the same distance one behind the other and each have a transporting clamp 10, for example according to one of the embodiments shown in FIGS. 5 to 10. In this case, however, the slide 42 is provided with a stop 100 at its two ends rather than with a follower element 44. The control arrangement 48, for displacing predetermined transporting clamps 10, has a star wheel 102 which is arranged to the side of the conveying section 16 and is driven synchronously with the conveying elements 17. A shank 106 is mounted such that it can be retracted and extended telescopically on each spoke 104 of the star wheel, a roller acting as a control element 108 being mounted in a freely rotatable manner at the free end of said shank. In each case one control element 108 comes into contact with each transporting clamp 10. If said control element is located in the rest position 110, as seen in the radial direction of the star wheel 102, the relevant slide 42 is not displaced. If, however, the control element 108 has been extended radially outward from the rest position 110 into the displacement position 110′, it comes into abutment against the stop 100 of the associated transporting clamp 10 and displaces the latter in the displacement direction 20 into the position 22 or 24 further remote from the hub of the star wheel 102. Downstream of said control arrangement 48, it is possible for a further identical control arrangement 48 to be arranged on the other side of the conveying section 16 in order for transporting clamps 10 of certain guide elements 40 to be displaced in the opposite direction.

The control arrangements shown may be activated by a computer which tracks the articles as they are transported along the conveying section 16, in order for precisely predetermined articles 14 of the series of articles to be displaced.

It is conceivable for it to be possible for the displacement direction to run obliquely in relation to the conveying section 16 rather than in the direction of the latter or at right angles thereto.

1. An arrangement for transporting, in particular, sheet-like articles, such as printed products and the like, having conveying elements (17) which can be moved along a conveying section (16) and are arranged one behind the other, and having transporting clamps (10) which are each arranged on a conveying element (17), characterized in that the transporting clamps (10) are mounted on the conveying elements (17) such that they can be displaced back and forth between at least two positions (22, 24) in a displacement direction (20) which is determined in relation to the conveying section (16), and in that by means of a stationary control arrangement (48), predetermined transporting clamps (10) moved past the latter are to be displaced from one position (22, 24) into the other.

2. The arrangement as claimed in claim 1, characterized in that the displacement direction (20) runs transversely, preferably at right angles, to the conveying section (16).

3. The arrangement as claimed in claim 1, characterized in that the displacement direction (20) runs in the direction of the conveying section (16).

4. The arrangement as claimed in one of claims 1 to 3, characterized in that the clamp plane (18) of the transporting clamps (10) runs in, or at right angles to, the displacement direction (20).

5. The arrangement as claimed in one of claims 1 to 4, characterized by a retaining arrangement (76) which is preferably designed as a latching arrangement (78), is assigned to each transporting clamp (10) and is intended for releasably retaining the transporting clamp (10) in relation to the conveying element (17) in one of the positions (22, 24), preferably in both positions.

6. The arrangement as claimed in one of claims 1 to 5, characterized in that guide elements (40), which run in the displacement direction (20) and are intended for the transporting clamps (10), are arranged in a fixed manner on the conveying elements (17).

7. The arrangement as claimed in one of claims 1 to 6, characterized in that each transporting clamp (10) has a follower element (44) which can be moved, by means of the control arrangement (48), from a rest position (44′) into an operating position (44″) and back again, and in that the control arrangement (48) has a stationary displacement element (52), which is preferably designed as a guide element and with which only follower elements (44) which have been displaced into the operating position (44″) interact, in order for the relevant transporting clamps (10) to be displaced from one position (22, 24) into the other.

8. The arrangement as claimed in one of claims 1 to 6, characterized in that each transporting clamp (10) has a stop (100) and the control arrangement (48) has a control element (108) which—in order for a transporting clamp (10) to be displaced from one position (22, 24) into the other—can be changed over from a rest position (110) into a displacement position (110′) and is intended for interacting with the stop (100) of the relevant transporting clamp (10).

9. The arrangement as claimed in one of claims 1 to 8, characterized in that the transporting clamps (10) have two clamping elements (12), which can be moved relative to one another from an open position into a clamping position and back again, and one of the clamping elements (12) is provided, at its free end, with a deflecting element (98) which is wedge-shaped in the displacement direction (20).
